(19) United States
(12) Patent Application Publication
(10) Pub. No.: US 2009/0126406 A1
(43) Pub. Date: May 21, 2009

(54) MANUFACTURING METHOD AND HEAT DRAWING APPARATUS FOR GLASS MEMBER

(75) Inventor: Hideki Ishikawa, Hiratsuka-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/266,033

(22) Filed: Nov. 6, 2008

(30) Foreign Application Priority Data
Nov. 20, 2007 (JP) 2007-300516

(51) Int. Cl. C03B 17/06

(52) U.S. Cl. 65/90; 65/193

(57) ABSTRACT

Since dispersion of height dimension is reduced in a spacer, it is possible to increase a yield in manufacturing processes and reduce a lord for inspecting products. There is provided a method of manufacturing a plate glass member to be used in an electronic device, the manufacturing method comprising: introducing a glass base material analogous to the glass member into a furnace body of which the temperature has been held equal to or higher than a softening temperature of the glass base material; heat-drawing the glass base material within the furnace body; and extracting the heat-drawn glass base material outside the furnace body, wherein the glass base material is introduced into the furnace body as a gap between the glass base material and an inner wall of the furnace body is shielded at a slot of the furnace body for the glass base material.

### BACKGROUND OF THE INVENTION

1. Field of the Invention

The present invention relates to a manufacturing method of a glass member, which is used for an electronic device, such as a spacer which is positioned between a pair of substrates in an electronic equipment or an electrical equipment to support these substrates, and to a heat drawing apparatus which is used in the manufacturing method.

2. Description of the Related Art

In recent years, a panel display in which a rear substrate, on which electron emitting devices are arranged in a matrix, and a front substrate, which is equipped with a fluorescent body for emitting light in response to irradiation of electrons emitted from the electron emitting devices are air-tightly joined together has been developed.

As a method of manufacturing a spacer for supporting the substrates of the display like this, a heat drawing method is disclosed in, for example, Japanese Patent Application Laid-Open No. 2000-164129 (corresponding to U.S. Pat. No. 6,517,399). In the heat drawing method, a glass base material of which the cross section is rectangle is heated and softened, and the softened glass base material is drawn by a difference between discharging speed of a discharging roller for discharging the glass base material and extracting speed of an extracting roller for extracting the glass base material. Since the shape at cross section of the glass base material which was drawn is analogous to the shape at cross section of the glass base material which is not yet drawn, a desired plate spacer is formed by cutting the drawn glass base material.

The spacer mainly functions to support the substrates against the atmospheric pressure applied from the outside of the panel display by maintaining a distance (gap) between the substrates which are in a reduced-pressure state. However, in this case, if dimensional dispersion among the spacers which are used to maintain the gap between the substrates is large, a fear that the substrates are deformed due to the atmospheric pressure increases. Moreover, a fear that the substrate itself cracks increases.

A permissible value of the dimensional dispersion to prevent such problems as above varies according to the size of the panel display, the thickness of the substrate, and the arrangement of the spacer. In the panel display of which the size is within the range of 30 to 60 inches, a requested dispersion range is generally 8 μm or less. More specifically, if it is assumed that a gap design value between the substrates is an arbitrary value within the range of 1.6 mm to 2 mm, a permissible tolerance of the dispersion in regard to height is ±0.2% to ±0.25%.

However, the outer dimension of the spacer manufactured in the above-described heat drawing method conventionally includes dispersion of ±0.3% to ±0.5% even if the spacer is high-precisely manufactured. For this reason, there are problems that a burden for inspecting products increases and a manufacturing yield decreases.

### SUMMARY OF THE INVENTION

The present invention, which has been completed in consideration of the above-described conventional problems, aims to, in manufacturing of a glass member in the heat drawing method, reduce dispersion of dimensional accuracy, reduce a burden for inspecting products, and increasing a manufacturing yield.

A first of the present invention is characterized by a method of manufacturing a plate glass member to be used in an electronic device, the manufacturing method comprising: introducing a glass base material analogous to the glass member into a furnace body of which the temperature has been held equal to or higher than a softening temperature of the glass base material; heat-drawing the glass base material within the furnace body; and extracting the heat-drawn glass base material outside the furnace body, wherein the glass base material is introduced into the furnace body as a gap between the glass base material and an inner wall of the furnace body is shielded at a slot of the furnace body for the glass base material.

A second of the present invention is characterized by a heat drawing apparatus which manufactures a glass member by heat-drawing a glass base material in a heat drawing method, the apparatus comprising: a furnace body, into which the glass base material is introduced, adapted to heat the introduced glass base material, wherein the furnace body includes a shielding member for shielding a gap between the glass base material and an inner wall of the furnace body at a slot for the glass base material.

According to the present invention, a plate glass member can be manufactured precisely by the heat drawing method. In particular, since dispersion of height dimension is reduced in a spacer, it is possible to increase a yield in manufacturing processes and reduce a lord for inspecting products.

Further features of the present invention will become apparent from the following description of the exemplary embodiments with reference to the attached drawings.

### BRIEF DESCRIPTION OF THE DRAWINGS

FIG. 1 is a cross-sectional view schematically indicating structure of an example of a heat drawing apparatus in the present invention.

FIG. 2A is a plan view of a sheet material fixed to a furnace body of the heat drawing apparatus indicated in FIG. 1, and FIG. 2B is a schematic cross-sectional view indicating a state that a glass base material passes through a passage opening provided in the sheet material.

FIG. 3 is a perspective view indicating an example of a glass member which can be obtained in the present invention.

### DESCRIPTION OF THE EMBODIMENTS

As a result of practicing a keen examination, the present inventor has attained the present invention by reaching the knowledge that an effect by the outer turbulent air outside a furnace body, which intrudes into the furnace body from a gap between a glass base material and an inner wall of the furnace body when the glass base material is introduced into the furnace body, is serious in a manufacturing process of a glass member performed by a heat drawing method.

The feature of the present invention is to shield the gap between the glass base material and an inner wall of the furnace body in a slot of the furnace body when the glass base material is introduced into the furnace body. Specifically, a shielding member, which has a base material passage opening smaller than a cross section of the glass base material on a central part of a flexible sheet material on which several slits are formed toward the periphery of the sheet from the passage opening, is preferably used as a shielding means. The sheet material is fixed to the furnace body so as to plug the slot, that is, so as to block the moving direction of the glass base material, which passes through the passage opening while widening the passage opening by pushing the slits. In this case, an edge part at a side of the passage opening in the sheet material excellently shields the gap between the glass base material and an inner wall of the furnace body by contacting with a surface of the glass base material which passes through the passage opening.

In the present invention, a foil material consisted of rare metal such as Pt is preferably used as the above-mentioned sheet material.

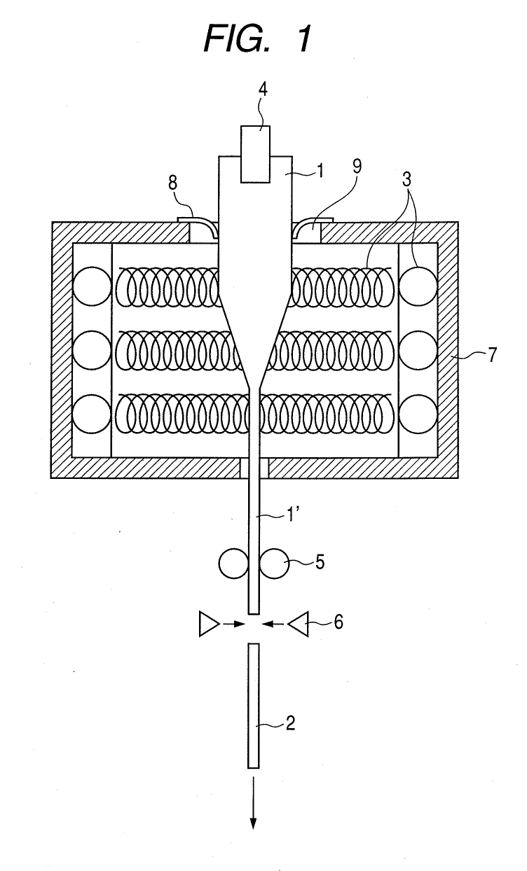

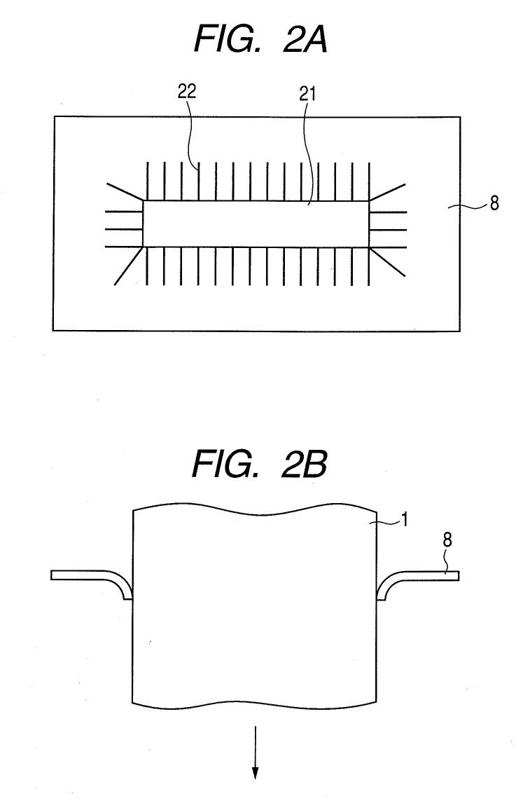

FIG. 1 is a schematic cross-sectional view in the vertical direction (drawing direction) indicating the structure of an embodiment of a heat drawing apparatus in the present invention capable of excellently performing a manufacturing method of the glass member in the present invention. In FIG. 1, reference numeral 1 denotes a glass base material; 1′ a glass base material after performing a drawing process; 2 a glass member; 3 a heater; 4 a mechanical-chuck; 5 a pair of rollers; 6 a pair of cutters; 7 a furnace body; 8 a sheet material; and 9 a slot of the furnace body into which the glass base material introduced. FIG. 2A is a plan view of the sheet material 8 indicated in FIG. 1. In FIG. 2A, reference numeral 21 denotes a base material passage opening and reference numeral 22 denotes slits. In addition, FIG. 2B is a schematic cross-sectional view in the vertical direction indicating a state that the glass base material 1 passes through the base material passage opening 21 provided in the sheet material 8.

In the present embodiment, since the base material passage opening 21 provided in the sheet material 8 serving as a shielding member is formed to be smaller than a cross section (cross section orthogonal to the drawing direction) of the glass base material 1, the glass base material 1 can not pass through the base material passage opening 21 if the above situation remains as it is. However, since several slits 22 are formed toward the periphery of the sheet material 8 from the passage opening 21, the passage opening 21 can be widened by pushing the slits 22. Accordingly, as indicated in FIG. 2B, the glass base material 1 passes through the passage opening 21 while keeping a state that an edge part of the sheet material at a side of the passage opening contacts with a surface of the glass base material 1, which is introduced into the furnace body 7. At this time, since a gap between the glass base material 1 and an inner wall of the slot 9 of the furnace body 7 is excellently shield by an edge part at a side of the passage opening provided in the sheet material 8, it can be prevented that an effect by the outer turbulent air outside the furnace body intrudes into the furnace body from the slot 9 when the glass base material 1 is introduced into the furnace body 7. By preventing intrusion of the outer turbulent air, the temperature fluctuation in the furnace body can be suppressed, and the glass member can be precisely heat-drawn.

In the present invention, the sheet material 8 can almost shield the gap between the glass base material 1 and the inner wall of the slot 9 of the furnace body 7 even by using one piece of the sheet. However, it is preferably adopted to use plural pieces of the sheet materials having the slits 22, of which positions are shifted each other, with a state of overlapping the sheet materials in order to obtain the more excellent shielding effect. By using plural pieces of the sheet materials with a state of overlapping them, portions that the slits of a first sheet material are widened and a gap that the sheet material does not contact with a surface of the glass base material can be shielded by a second and the next sheet materials, and the above-mentioned gap can be almost completely shielded.

A shape, which is formed by a line of joining edge portions at a periphery side of the slits 22 formed toward the periphery of the sheet material 8 from the base material passage opening 21 provided in the sheet material 8, is a rectangular form analogous to a cross section of the glass base material 1 in FIG. 2A. However, the present invention is not limited to this shape. Corresponded shapes can be properly selected from among other shapes such as a circular form, an elliptical form or a rectangular form of lacking angle portions within a scope capable of obtaining the more excellent shielding effect. Furthermore, in case of using the plural sheet materials with a state of overlapping them, the corresponded shapes may be different from each other every the sheet material.

In FIG. 1, the heaters 3 serving as the heat sources are disposed for the glass base material 1 with a state of having just about the same distance from each of outer sides of cross sections orthogonal to the drawing direction of the glass base material 1. Although a cross-sectional shape of the glass base material 1 in the present embodiment is a rectangular form, the present invention is not limited to the glass base material 1 having such the cross-sectional shape but is also available to the glass base material 1 of which a cross-sectional shape has different longitudinal and lateral sizes, for example, the glass base material 1 of which the cross-sectional shape is an elliptical form or a trapezoidal form. As just described, even if the cross-sectional shape of the glass base material 1 is complex, the same shielding effect can be obtained by overlapping the plural sheet materials 8 on which the slits 22 were formed.

In an apparatus indicated in FIG. 1, the glass base material 1 is tightened up by the mechanical-chuck 4 to be held, a lower part of the glass base material 1 which passed through the passage opening 21 provided in the sheet material 8 is heated by the heaters 3 to reach such the temperature equal to or higher than a softening temperature of the glass base material 1, and a lower part of the drawn glass base material 1′ is pinched between a pair of pick-up rollers 5. With this state, the pick-up rollers 5 are rotated while gradually descending the mechanical-chuck 4, and the drawn glass base material 1′ is picked up with a picking-up speed faster than a descending speed of the mechanical-chuck 4. At the same time, the glass base material 1 is heated to a temperature equal to or higher than a softening temperature by the heaters 3 and softened between the mechanical-chuck 4 and the pick-up rollers 5.

Then, the glass base material 1, which was heated to the temperature equal to or higher than the softening temperature and softened, is drawn by a speed difference between the descending speed of the mechanical-chuck 4 and the picking-up speed kept by the pick-up rollers 5, and the drawn glass base material 1′ of which a cross-sectional shape is almost analogous to that of the glass base material 1 can be continuously formed.

And, the drawn glass base material 1′, which passed through the pick-up rollers 5 with a state of cooled and solidified, is cut by the cutter 6, thereby realizing to form a plate (including a column part) glass member 2 having a desired thickness.

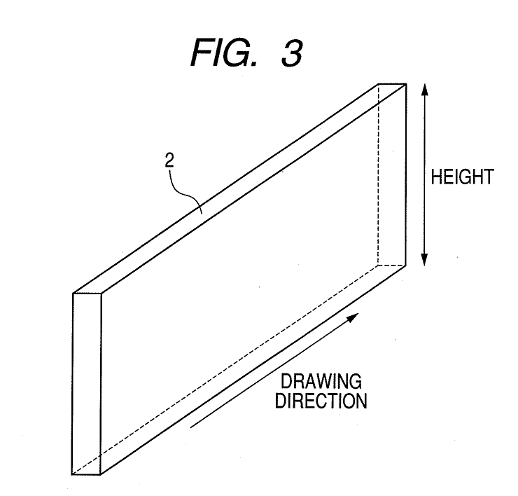

FIG. 3 is a perspective view of an example of the glass member 2 which is obtained by the apparatus indicated in FIG. 1 and used as a spacer in a display apparatus.

### EMBODIMENTS

### Embodiment 1

The glass member 2 indicated in FIG. 3 was manufactured by the heat drawing apparatus indicated in FIG. 1. As the glass base material 1, a material, of which a cross-sectional shape is a rectangular form of 6.2 mm×49 mm, was used. As for a shielding member, the passage opening 21, of which shape is a rectangular form of 5.2 mm×40 mm, is provided in the central vicinity of the platinum-containing sheet material 8, of which thickness is 0.03 mm, and the slits 22, of which a pitch is 3 mm and the cut length is 5 mm, are cut in the sheet material toward the periphery of the sheet material from the passage opening 21, as indicated in FIG. 2A. And, the sheet material 8 is fixed to the slot 9 for the glass base material 1 of the furnace body 7 so as to plug the slot.

The glass base material 1 is sent out by descending the mechanical-chuck at a speed of V1 being equal to 2.5 mm/min, and is heated to about 780° C. by the heaters 3. Then, the glass base material 1 is heat-drawn by picking up at a speed of V2 being approximately equal to 2700 mm/min by the pick-up rollers 5 arranged below the heaters 3 and is lastly cut by the cutter 6 so as to set the length to become 850 mm.

When the height (refer to FIG. 3) of the glass member 2 obtained in the present embodiment is measured in a laser length measuring machine with a pitch of 1 mm for 300 portions, the height is in a range from 1.5965 mm to 1.6035 mm (range 7.0 μm) at all the measuring points. In addition, the dispersion 3σ was in a range of ±3.2 μm (±0.2%).

### Comparative Example 1

The glass member 2 was manufactured similar to a case in the Embodiment 1 excepting points that a size of the base material passage opening 21 provided in the sheet material 8 is set to become 7.2 mm×50 mm (each of sides is set to become 0.5 mm longer than an outer circumference of the glass base material 1) and the slits 22 are not formed.

When the same measurement as that in the Embodiment 1 was performed to the glass member of the present example, the height is in a range from 1.5946 mm to 1.6069 mm (range 12.3 μm), and the dispersion 3σ was in a range of ±6.7 μm (±0.42%).

### Comparative Example 2

The glass member was manufactured similar to a case in the Embodiment 1 excepting points that a size of the base material passage opening 21 provided in the sheet material 8 is set to become 8.2 mm×51 mm (each of sides is set to become 1 mm longer than an outer circumference of the glass base material 1) and the slits 22 are not formed.

When the same measurement as that in the Embodiment 1 was performed to the glass member of the present example, the height is in a range from 1.5940 mm to 1.6012 mm (range 12.2 μm), and the dispersion 3σ was in a range of ±5.4 μm (±0.34%).

### Comparative Example 3

The glass member was manufactured similar to a case in the Embodiment 1 excepting points that a size of the base material passage opening 21 provided in the sheet material 8 is set to become 12.2 mm×55 mm (each of sides is set to become 3 mm longer than an outer circumference of the glass base material 1) and the slits 22 are not formed.

When the same measurement as that in the Embodiment 1 was performed to the glass member of the present example, the height is in a range from 1.5950 mm to 1.6098 mm (range 14.8 μm), and the dispersion 3σ was in a range of ±6.0 μm (±0.38%).

While the present invention has been described with reference to the exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-300516, filed Nov. 20, 2007, which is hereby incorporated by reference herein in its entirety.

What is claimed is:

1. A method of manufacturing a plate glass member to be used in an electronic device, the manufacturing method comprising:
introducing a glass base material analogous to the glass member into a furnace body of which the temperature has been held equal to or higher than a softening temperature of the glass base material;
heat-drawing the glass base material within the furnace body; and
extracting the heat-drawn glass base material outside the furnace body,
wherein the glass base material is introduced into the furnace body as a gap between the glass base material and an inner wall of the furnace body is shielded at a slot of the furnace body for the glass base material.

2. A method according to claim 1, wherein
the gap between the glass base material and the inner wall of the furnace body is shielded by a flexible sheet material,
the sheet material includes a base material passage opening of which the size is smaller than the section of the glass base material and plural slits extending from the base material passage opening toward the periphery of the sheet material, and
the glass base material is introduced into the furnace body in a state that the base material passage opening is widened by the slits, as bringing the glass base material into contact with the sheet material.

3. A heat drawing apparatus which manufactures a glass member by heat-drawing a glass base material in a heat drawing method, the apparatus comprising:
a furnace body, into which the glass base material is introduced, adapted to heat the introduced glass base material,
wherein the furnace body includes a shielding member for shielding a gap between the glass base material and an inner wall of the furnace body at a slot for the glass base material.

4. A heat drawing apparatus according to claim 3, wherein
the shielding member is a sheet material including noble metal, and
the sheet material includes, at the center thereof, a base material passage opening of which the size is smaller than the section of the glass base material and plural slits extending from the base material passage opening toward the periphery of the sheet material.
